(19) United States
(12) Patent Application Publication
(10) Pub. No.: US 2006/0039840 A1
(43) Pub. Date: Feb. 23, 2006

(54) Device and methods for the production of chlorine dioxide vapor

(75) Inventors: James Liang-Hiong Chia, Colombus, OH (US); Bernardo N. Rico, Lewis Center, OH (US)

Correspondence Address: SPECKMAN LAW GROUP PLLC, 1501 WESTERN AVE, SEATTLE, WA, 98101, US

(73) Assignee: AVANTEC TECHNOLOGIES, INC., Columbus, OH (US)

(21) Appl. No.: 10/921,385

(22) Filed: Aug. 18, 2004

(51) Int. Cl. C01B 11/02

(52) U.S. Cl. 422/305; 423/477

(57) ABSTRACT

A device for producing chlorine dioxide vapor in a time release manner when exposed to ambient moisture is provided. The device comprises two outer membranes and an inner membrane. The outer and inner membranes are sealed together along the edges of the device. The outer and inner membranes together form a pouch comprising two separate compartments separated by the inner membrane. Each compartment is provided with a dry reactant (e.g. an acid component and a metal chlorite component) for producing chlorine dioxide vapor. The outer membranes are permeable to moisture and chlorine dioxide vapor, and impervious to liquid water and the dry reactants. The acid component in one of the compartments is hydrated by the moisture penetrated through the outer membranes, and the hydrated acid component is absorbed by the inner membrane and transported across the inner membrane to come into contact with the metal chlorite component in the other compartment to produce chlorine dioxide vapor. The chlorine dioxide vapor eventually slowly diffuses out of outer membranes into the surrounding environment.

### FIELD OF THE INVENTION

The present invention relates generally to a device for producing chlorine dioxide vapor, and particularly to a device that produces chlorine dioxide vapor when it is exposed to water and/or moisture.

### BACKGROUND OF THE INVENTION

Chlorine dioxide (ClO₂) is a relatively small, volatile, and versatile free radical molecule with bleaching, oxidizing, deodorizing, and antimicrobial, namely, bactericidal, viricidal, algicidal, and fungicidal, properties. It is frequently used to control microorganisms on or around food products because chlorine dioxide destroys the microorganisms without producing byproducts that pose a significant adverse risk to human health. Examples of these adverse byproducts include chloramines and chlorinated organic compounds. The physiological mode of destructing microbes by chlorine dioxide has been attributed to the destruction of cell walls and cell membranes and disrupting transport of nutrients from external environment into microbes.

In addition, chlorine dioxide has long been recognized for treatment of compounds producing odors through oxidation processes. Examples of these odor-causing compounds include: sulfur-containing compounds (hydrogen sulfide, mercaptan sulfides, organic disulfide, sulfoxides, etc.), oxygen containing compounds (phenols, aldehydes, aliphatic alcohols, etc.) and nitrogen containing compounds (tertiary and secondary amines, etc.). A low concentration of chlorine dioxide, in either gaseous or liquid state, is effective for most antimicrobial and deodorization applications.

Unfortunately, chlorine dioxide, in its vaporous state, is not stable during storage and can be explosive at concentrations above about 10% in dry air. Chlorine dioxide vapor can be compressed to a liquid state to reduce the risk of explosion. However, the compressed liquid chlorine dioxide can also be explosive, particularly at temperatures higher than −40° C. Therefore, chlorine dioxide vapor is not produced and shipped under pressure. It must generally be generated at the point of use via conventional chlorine dioxide generators or other means of generation. Conventional chlorine dioxide generation can be carried out in an efficient manner in connection with large-scale operations to produce chlorine dioxide by reacting sodium chlorite solution with an acid such as sulfuric acid or hydrochloric acid. Chlorine dioxide can also be generated by one of the following reactions: mixing sodium chlorite solution with a strong chlorine solution at low pH, mixing a sodium chlorite solution with chlorine gas at near neutral pH under a vacuum, or reacting solid sodium chlorite in a sealed reactor cartridge with humidified chlorine gas flowing through it. These processes require expensive generation equipment, high maintenance costs, and require highly trained and skilled workers to operate the equipment in a safe manner. As a result, the use of such generators has been limited to the fields of poultry processing, pulp and paper bleaching, and water treatment facilities, where the high capital and operating cost of the generators can be justified by the large consumption of chlorine dioxide.

In addition to the generation methods discussed above, chlorine dioxide can also be generated by the electrolysis of sodium chlorite solutions. This process requires electricity to operate the electrolytic equipment, and high maintenance efforts to ensure the efficiency of the equipment. The electrolysis process not only produces less chlorine dioxide compared to conventional generators, but special sodium chlorite solutions are also required for this process to reduce the level of suspended solids and scaling that to prevent clogging of the electrolytic cell. Further, proportional amount of wastes, such as sodium hydroxide solution, are produced along with chlorine dioxide during the electrolytic reaction.

A solution of a metal chlorite and water where the pH of the solution is maintained at 8 or above is sometimes referred to as a “stabilized chlorine dioxide” solution. Applications requiring small quantities of chlorine dioxide can be approached by the use of “stabilized chlorine dioxide”, which generally refers to sodium chlorite, a reactant of chlorine dioxide. Sodium chlorite by itself only has bacteriostatic properties (inhibits rather than killing bacteria) and does not provide complete disinfection. Some claims have been made to the use of sodium chlorite as a bactericide when bacteria can provide the necessary acidity for the “activation” step to produce chlorine dioxide. However, there is no scientific proof of this theory and, in any case, the amount of chlorine dioxide produced under these conditions is insignificant. Further, “stabilized chlorine dioxide” still requires the activation step of reacting a sodium chlorite solution with an acid. The pH of the reacting solution must be lowered to below 5, typically to a pH range between about 2 to about 3 in order to produce chlorine dioxide according to the following equation:
5ClO₂⁺+5H⁺→4ClO₂+HCl+2H₂O
This approach or any other type of “two-part system” is usually performed at the application site, requiring trained personnel to properly activate the product. In addition, the use of “stabilized chlorine dioxide” requires mixing equipment and manipulation of potentially dangerous acids, e.g., the danger associated with inadvertent skin contact and inhalation of acid vapors. Transportation of the “stabilized chlorine dioxide” also involves large volumes of water, resulting in a costly and difficult operation for remote and/or disaster recovery uses.

Attempts have also been made to manufacture devices that produce chlorine dioxide using a mixture of solid sodium chlorite and acidulant in solid forms (e.g. citric acid, sodium bisulfate, organic anhydride, etc.). These devices usually require complicated formulation processes, one of which involves the drying of individual reactants to lower their water content, the mixing of dried reactants in the presence of desiccant materials (e.g. calcium chloride) to prevent the premature generation of chlorine dioxide that is initiated by atmospheric moisture, and specially-designed environments that minimize moisture contact with mixed reactants during the formulation/packaging process. In addition, a protective barrier is required to prevent the contact of atmospheric moisture with the mixed reactants prior to use. In the presence of water/moisture, these devices generate chlorine dioxide solution or chlorine dioxide vapor. Due to the nature of the manufacturing process, these devices usually incur higher manufacturing costs.

Many compositions for generating chlorine dioxide solutions are known in the art. For example, U.S. Pat. No. 2,022,262 discloses stable stain-removing compositions made from a dry mixture of water-soluble alkaline chlorite salt, an oxalate and an acid. U.S. Pat. No. 2,071,091 discloses the use of chlorous acid and chlorites to kill fungi and bacterial organisms by exposing the organisms to the compounds at a pH of less than about 7. The patent also discloses using dry mixtures of chlorites and acids to produce stable aqueous solutions useful as bleaching agents. U.S. Pat. No. 2,482,891 discloses stable, solid, substantially anhydrous compositions comprising alkaline chlorite salts and organic acid anhydrides, which release chlorine dioxide when contacted with water. U.S. Pat. No. 2,071,094 discloses deodorizing compositions in the form of dry briquettes formed of a mixture of soluble chlorite, an acidifying agent, and a filler of relatively low solubility. Chlorine dioxide is generated when the briquettes contact water. U.S. Pat. No. 4,585,482 discloses a long-acting biocidal composition comprising a microencapsulated mixture of chlorite and acid that when added to water releases chlorine dioxide. The primary purpose of the microencapsulation is to provide for hard particles that will be free flowing when handled. The microencapsulated composition also protects against water loss from the interior of the microcapsule. The microcapsules produce chlorine dioxide when immersed in water. Unfortunately, the microcapsules release chlorine dioxide relatively slowly and are therefore not suitable for applications that require the preparation of chlorine dioxide on a relatively fast basis.

Many devices and methods for producing chlorine dioxide solution are also known in the art. For example, Canadian Patent No. 959,238 discloses using two water-soluble envelopes, one containing sodium chlorite and the other containing an acid, to generate chlorine dioxide solution. The envelopes are placed in water and the sodium chlorite and acid dissolve in the water and react to produce a chlorine dioxide solution. PCT Application PCT/US98/22564 (WO 99/24356) discloses a method and device for producing chlorine dioxide solutions wherein sodium chlorite and an acid are mixed and enclosed in a semi-permeable membrane device. When the device is placed in water, water penetrates the membrane. The acid and sodium chlorite dissolve in the water and react to produce chlorine dioxide. The chlorine dioxide exits the device through the membrane into the water in which the device is immersed producing a chlorine dioxide solution that can be used as an anti-microbial solution or for other purposes. The primary disadvantage of the disclosed device and method is that ambient moisture can penetrate the semi-permeable membrane and initiate the reaction prematurely.

In general, the above prior art devices and methods using membranes are susceptible to premature activation by water or water vapor and therefore have a reduced shelf life unless sufficient steps are taken to protect the devices from exposure to ambient moisture or water. Also, such devices and methods are typically slow to interact with water and produce the desired chlorine dioxide.

U.S. Pat. No. 6,764,661 discloses a device for producing an aqueous chlorine dioxide solution when placed in water that solves the aforementioned problem. One of the advantages of this device is that it is not susceptible to activation by ambient moisture. The device includes a membrane shell that defines a compartment, which includes one or more dry reactants (e.g., a metal chlorite and an acid) capable of producing chlorine dioxide when exposed to water. The device is provided with wick means extending into the compartment for absorbing water and transporting water into the compartment such that the reactant(s) in the compartment dissolve in the water and produce chlorine dioxide in an aqueous solution.

The above device, disclosed in U.S. Pat. No. 6,764,661, is generally used to produce an aqueous chlorine dioxide solution exposed to water. It is not designed to produce chlorine dioxide vapor.

### SUMMARY OF THE INVENTION

In accordance with the invention, a device for producing chlorine dioxide vapor upon exposure to water and/or moisture is provided. The device is capable of providing sustained generation of chlorine dioxide vapor over a long period of time (weeks to months) upon exposure to ambient moisture. The production of chlorine dioxide vapor is achieved by the inclusion of the reactants of chlorine dioxide vapor in a multi-compartment device. At least two compartments are provided, each having an outer membrane defining walls of the device and an inner membrane providing physical separation of the reactants. The outer membrane is moisture and chlorine dioxide permeable; and it is impermeable to liquid water and reactant powders. The inner membrane may be sealed to the outer membranes continuously or non-continuously along the edges of the device. In one embodiment, a chlorine dioxide vapor delivery device comprises at least two outer membranes and at least one inner membrane, which are sealed together continuously along the edges of the device, via a mechanical heat sealing process, to form a pouch with at least two inner compartments. The inner membrane physically separates the dry reactants (generally, a metal chlorite component and an acid component). The inner membrane is capable of absorbing and transporting small amounts of partially dissolved acid and moisture across the inner membrane to react with the metal chlorite in a separate component chamber.

In this embodiment, separate compartments of the device contain a metal chlorite component and an acid component. When the device is exposed to the environment, the ambient moisture penetrates the outer membranes. The metal chlorite component and the acid component then become hydrated and slowly dissolve. The partially dissolved reactants come into contact with each other across the inner membrane to produce chlorine dioxide vapor. Eventually, the generated chlorine dioxide vapor slowly diffuses out of the outer membranes into the surrounding environment. The higher the moisture level, the faster the reactants are hydrated, and hence the faster the chlorine dioxide vapor is produced.

In another embodiment, the device comprises an inner membrane and two outer membranes, which are sealed together non-continuously along the edges of the device, to form a pouch having a plurality of small openings along the edges of the device for facilitating passage of moisture into the device. The small openings or gaps may be mechanically compressed to prevent the reactants from falling out from the device. These small openings increase the moisture transfer rate into the device, the reactants' dissolution rate, chlorine dioxide vapor generation rate, as well as the rate of facilitating the passage of chlorine dioxide vapor out of the device. When the inner membrane is constructed of hydrophilic material, the device is capable of transporting water into the device through the wicking effect of the inner hydrophilic membrane. The transport of a small amount of water into the device through the small openings on the edges of the device significantly shortens the time required for the chlorine dioxide vapor to be produced, thereby accelerating the release of chlorine dioxide vapor.

To prevent premature chlorine dioxide vapor generation, the device may be packaged in a water-resistant envelope (e.g., a polyethylene pouch) or moisture-resistant envelope (e.g., a foil pouch).

In yet another embodiment, the device comprises an envelope or chamber containing two separate pouches or enclosures. The envelope or chamber is constructed from the same material as the outer membrane material described in the above embodiments, which is moisture and chlorine dioxide permeable. One of the two separate enclosures may be provided with the metal chlorite component while the other enclosure may be provided with the acid component. The two separate pouches are preferably made from the same material as the inner membrane material described in the above embodiments, which is capable of absorbing and transporting hydrated acid and metal chlorite components. The multi-compartment devices of the present invention, as described and claimed herein, are intended to encompass multiple chambers or multiple pouch devices such as that described above.

### BRIEF DESCRIPTION OF THE DRAWINGS

Preferred embodiments of the present invention are described in detail below and illustrated in the drawings, in which:

FIG. 1 shows a front elevational view of an embodiment of the inventive device;

FIG. 2 shows a cross sectional view of the device of FIG. 1; and

FIG. 3 shows a front elevational view of another embodiment of the inventive device, where the two outer membranes and inner membrane of the device are mechanically heat-sealed together.

### DETAILED DESCRIPTION OF THE INVENTION

A device is provided for producing chlorine dioxide vapor when exposed to ambient moisture. The device is capable of producing chlorine dioxide vapor via a time release manner. In other words, the production of chlorine dioxide vapor may be slow released over a relatively long period of time (weeks to months), or an accelerated release may be provided depending on the construction of the device and arrangement of components. Over time, the release of chlorine dioxide vapor reaches the maximum amount released and then the release levels off and eventually decreases to zero.

The device is provided with an inner membrane that defines and separates a first and a second compartment. These compartments house one or more dry reactants (e.g., a metal chlorite and an acid) capable of producing chlorine dioxide vapor when the reactants are exposed to ambient moisture. At least two compartments are provided, each having an outer membrane defining walls of the device. The outer membrane is moisture and chlorine dioxide permeable; and it is impermeable to liquid water and reactant powders. The inner membrane may be sealed to the outer membranes continuously or non-continuously along the edges of the device. As used herein and in the claims, the term “dry reactant components” means reactant components in a stable, solid, substantially anhydrous form; the term “metal chlorite component” means a compound which is a metal chlorite or which forms a metal chlorite when exposed to solvents, moisture and/or an acid component; the term “acid component” means a compound which is acidic or which produces an acidic environment in the presence of water/moisture sufficient to activate or react with the metal chlorite components such that chlorine dioxide is produced.

The production of chlorine dioxide vapor via the inventive device is a clear function of relative humidity. The device generates higher amounts of chlorine dioxide vapor at a higher rate of generation when it is placed in an environment with high humidity. In an environment with low humidity, the device produces less chlorine dioxide vapor at a lower rate of generation.

The inner membrane of the inventive device is capable of absorbing and transporting small amounts of partially dissolved acid across the membrane to the compartment containing the metal chlorite. The inner membrane also serves to facilitate the transfer of moisture from one compartment to the other. The structure of this inner membrane has unique physical properties. The inner membrane has a high absorbent capacity and absorbency rate in water, oil, and solvents. The inner membrane is preferably hydrophilic, capable of transmitting air or gases (e.g. Frazier porosity>10 ft³/ft² min). The inner membrane is preferably also ultra strong, durable, abrasion resistant (e.g. able to withstand tensile strength of 15-30 lbs) and chemically resistant. It is important that the inner membrane is chemically resistant in dry and/or wet conditions in the presence of acidic and/or oxidizing environments, so that the membrane is not degraded or ruptured during placement or operation. The inner membrane is generally made of non-woven materials, preferably made of material generated from a spun lacing process (e.g. hydro entangling process). Materials produced from this process have high absorbent capacities and absorbency rates in water, oil, and solvents. In addition, the materials are ultra strong, durable, and abrasion resistant.

The inventive device has utility as an odor-destroying device when used in confined spaces. Specific applications include the destruction of odor-causing bacteria in basements, refrigerators, storage containers, etc.

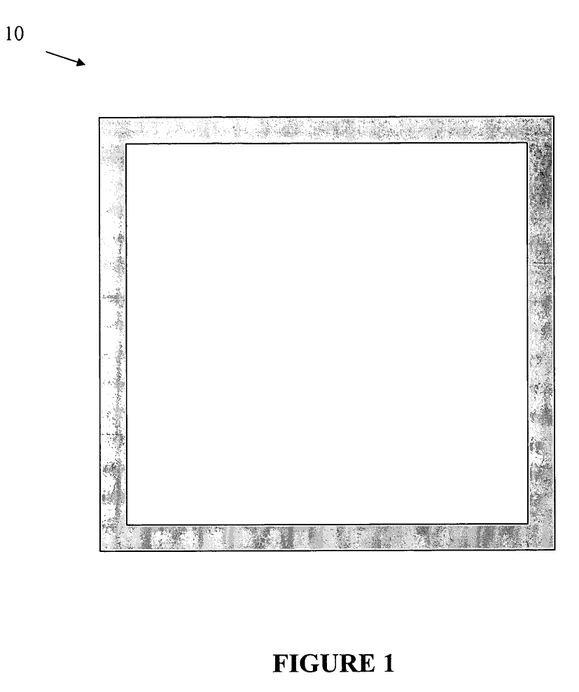

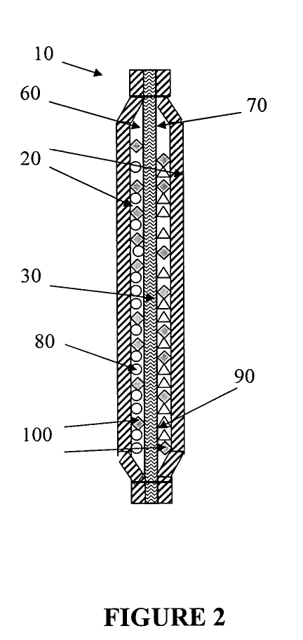

FIG. 1 and FIG. 2 show an embodiment of the inventive device for producing chlorine dioxide vapor when the device is exposed to ambient moisture. The device 10, as shown in FIG. 2, is provided with at least two outer membranes 20 and at least one inner membrane 30. In this embodiment, the outer membranes 20 and the inner membrane 30 are sealed together continuously along four edges of the device 10, forming a pouch with a first inner compartment 60 and a second inner compartment 70. The compartments 60, 70 are provided with dry reactant components, or reactants 80, 90 capable of producing chlorine dioxide vapor when the components 80, 90 react with ambient moisture. The two outer membranes 20 function as a physical barrier, or wall, that separates the dry reactants 80, 90 of the chlorine dioxide vapor from the environment. The inner membrane 30 provides the physical separation of the dry chlorine dioxide reactants 80, 90.

In the embodiment as shown in FIG. 2, the dry reactant components 80, 90, capable of producing chlorine dioxide vapor upon exposure to moisture in the air, are preferably a metal chlorite component 80 and an acid component 90. When the device 10 is exposed to the environment, the moisture in the air naturally penetrates the two outer membranes 20. As the moisture reaches the metal chlorite component 80 and acid component 90, the components become hydrated and slowly become partially dissolved adjacent to the inner membrane 20. The partially dissolved reactants 80, 90 then come in contact with each other via the inner membrane 30 to produce chlorine dioxide vapor with the following reactant reaction:
5 ClO₂⁻5H⁺→4 ClO₂+HCl+2H₂O.
Eventually, the generated chlorine dioxide vapor slowly diffuses out of the outer membranes 20 into the surrounding environment.

In addition to the metal chlorite component 80 and acid component 90, additives 100 such as catalyst, deliquescent materials, and other dry reactant components capable of enhancing/facilitating or slowing the rate of chlorine dioxide production may also be provided in the compartments 60, 70, or in additional compartments. To prevent premature chlorine dioxide vapor production, it is critical that the dry metal chlorite component 80 and acid component 90 are physically separated. If the dry components 80, 90 are mixed with each other prior to use, chlorine dioxide vapor may be generated prematurely and reduce the shelf life of the device 10.

The outer membranes 20 may be constructed from any membrane material that allows the membranes to function as a physical barrier that separate the dry reactant components 80, 90, 100 from the environment but are permeable to ambient moisture. The outer membranes 20 are substantially impervious to water and reactant powders but permeable to ambient moisture and chlorine dioxide vapor. The outer membrane materials may be naturally occurring, synthetic, woven, non-woven, or hydrophobic. Additionally, the materials may be coated or non-coated, and may be multi-layered. It is important that the outer membrane has a small mean flow pore size and bubble point (e.g. <10 microns) and low water permeability, so that it is impervious to water while allowing moisture, air and gases to pass through (e.g., Gurley Hill Porosity of 22 seconds/100 cc). In addition, the outer membrane preferably has high tensile strength and pressure, and is chemically resistant. Some examples of suitable synthetic materials for the outer membranes 20 may include, but are not limited to: polyvinyl chloride, polyvinyl fluoride, polyvinylidene chloride, polytetrafluoroethylene, polyacrylics such as Orlon®, polyvinyl acetate, polyethylvinyl acetate, non-soluble or soluble polyvinyl alcohol, polyolefins such as polyethylene and polypropylene, polyamides such as nylon, polyesters such as Dacron® or Kodel®, polyurethanes, polystyrenes, and the like. Outer membranes 20 may also be constructed from: micro porous non-woven polyethylene polymer sheet materials (e.g., Tyvek® brand material sold by Dupont), micro porous non-woven polypropylene materials, expanded polytetrafluoroethylene (e.g., Gore-Tex® brand sold by W. L. Gore), and Kraft paper (e.g., X-Crepe-N Grade 4502 sold by Oliver Products Co.), and the like.

The material of the inner membrane 30 may comprise hydrophilic materials or a combination of hydrophilic and hydrophobic materials that exhibit hydrophilic properties. For example, the inner membrane 30 may be constructed from virtually any material is capable of absorbing moisture/water and transporting the absorbed moisture/water from one compartment to another. At the same time, the inner membrane 30 separates the dry metal chlorite component 80 and the dry acid component 90. Examples of suitable natural materials for the inner membrane 30 include, but are not limited to: cotton, Esparto grass, bagasse, hemp, flax, silk, wool, wood pulp, reactantly modified wood pulp, jute, rayon, ethyl cellulose, and cellulose acetate, and the like. Suitable synthetic materials for the inner membrane 30 may include, but are not limited to: polyvinyl chloride, polyvinyl fluoride, polytetrafluoroethylene, polyvinylidene chloride, polyacrylics such as Orlon®, polyvinyl acetate, polyethylvinyl acetate, non-soluble and soluble polyvinyl alcohol, polyolefins such as polyethylene and polypropylene, polyamides such as nylon, polyesters such as Dacron® or Kodel®, polyurethanes, polystyrenes, and the like. In addition, the materials may be made of the combination of natural materials and synthetic materials that are derived from nonwoven technologies. One preferred process for producing non-woven materials is a spun lacing process (hydro entangling process). Materials produced by this process contain no binders or glues, are low-linting, have high texture-like and high absorbent capacity and absorbency rates in water, oil and solvents. In addition, they are ultra strong, durable, and abrasion resistant. Examples of these materials are Sontara® engineered-cloth wipers produced by Dupont® (Sontara® AC™, Sontara® SPS™, Sontara® FS™, Sontara® EC™, Sontara® ERC™, Sontara® PC™).

The metal chlorite component 80 generally comprises a metal chlorite selected from the group consisting of: alkali metal chlorites, alkaline earth metal chlorites, and mixtures thereof. Preferably, the metal chlorite component 80 is selected from the group consisting of: sodium chlorite, potassium chlorite, barium chlorite, calcium chlorite, and magnesium chlorite, and more preferably from the group consisting of: sodium chlorite, calcium chlorite, potassium chlorite, and mixtures thereof. Most preferably, the metal chlorite component is sodium chlorite (NaClO₂), particular dry technical grade sodium chlorite (containing about 80% by weight sodium chlorite and 20% by weight of sodium chloride, sodium chlorate and others).

The acid component 90 may be, but is not limited to, an organic acid, a mineral acid, acid treated materials or mixtures thereof. It is preferably a dry solid hydrophilic compound, which does not substantially react with the metal chlorite until the reactant is partially dissolved and comes in contact through the inner membrane 30. Examples of the organic acids may include, but are not limited to: citric acid, boric acid, lactic acid, tartaric acid, maleic acid, malic acid, glutaric acid, adipic acid, acetic acid, formic acid, sulfamic acid and mixture thereof. Examples of mineral acids may include, but are not limited to: sulfuric acid, hydrochloric acid, phosphoric acid and mixtures thereof. Preferred mineral acids are those that are of food grade quality, such as phosphoric anhydride and sulfuric anhydride. Alternatively, an acid reactant that produces an acid when exposed to water may also be used. Examples of suitable acid reactants may include, but are not limited to: water soluble organic acid anhydrides, such as maleic anhydride, and water soluble acid salts, such as calcium chloride, magnesium chloride, magnesium nitrate, lithium chloride, magnesium sulfate, aluminum sulfate, sodium acid sulfate, sodium dihydrogen phosphate, potassium acid sulfate, potassium dihydrogen phosphate, and mixtures thereof. Additional water-soluble acid forming reactants are known to those skilled in the art.

The amount of each reactant that is placed in the device 10 varies and depends on the size of the device 10 and the desired amount of chlorine dioxide vapor produced. The reactants are preferably in powder form, or another form that is highly susceptible to moisture.

In the embodiment as shown in FIG. 2, a metal chlorite component 80 and an acid component 90 are placed separately in the first and second compartments 60, 70 of the device 10. The weight ratio of the metal chlorite component 80 to acid component in the device 10 is approximately in the range from about 1:100 to about 100:1; more preferably approximately in the range from about 1:1 to 1:10.

The types of additive to be provided in the device 10, either in the first compartment 60, or the second compartment 70, also vary and depend on the intended application, the types of metal chlorite component 80 and acid component 90 used, packaging concerns, and material compatibility. Examples of additives that may include, but are not limited to: adhesive, thickeners, penetrating agents, stabilizers, surfactants, binders, organic solids, inorganic solids, catalysts, desiccants, deliquescent materials, fragrance-release compounds, and other components that are capable of enhancing/facilitating or slowing the production of chlorine dioxide vapor when the device 10 is exposed to ambient moisture.

A catalytic amount of a deliquescent material may be added to the first or second compartment 60, 70, or to one or more additional compartments, to speed up the reaction to generate chlorine dioxide vapor. The deliquescent material may be a transition metal, a transition metal oxide, and mixtures thereof. The deliquescent material is capable of absorbing the ambient moisture and converting it to liquid water, and thereby increasing the hydration of the metal chlorite component 80 and acid component 90. Consequently, the partially dissolved metal chlorite component 80 and acid component 90 come in contact with each other through the inner membrane 30 to react and produce chlorine dioxide vapor. The amount of deliquescent material added to the compartments 60, 70 may be varied within a suitable range, depending on the desired reaction rate to generate chlorine dioxide. Examples of deliquescent materials may include, but are not limited to: potassium sulphate, calcium sulphate, ammonium sulphate, anhydrous sodium sulfate, sec. sodium phosphate, magnesium nitrate, calcium nitrate, magnesium acetate, barium chloride, magnesium chloride, aluminum chloride, calcium chloride, lithium chloride, sodium chloride, potassium chloride, ammonium chloride, potassium bromide, potassium carbonate, sodium carbonate, sodium nitrite and mixtures thereof.

The metal chlorite component 80, acid component 90, and any additive(s) utilized in connection with the inventive device 10 may be in any dry physical form. Examples of the dry physical form may include, but are not limited to: powders, granules, pellets, tablets, agglomerates, and the like. Preferably, the components are in powder form because powders have larger surface area, which tends to dissolve in water and react more quickly when compared to large particles, such as pellets or agglomerates.

Further, the metal chlorite component 80 and the acid component 90 may each be impregnated on inert carriers that are reactantly compatible with the components 80, 90. A carrier is useful to control the release of the metal chlorite component 80 and acid component 90, and thus the reaction may be further controlled. Examples may include, but are not limited to: zeolite, kaolin, mica, bentonite, sepiolite, diatomaceous earth synthetic silica, and the like.

In a preferred embodiment, the outer membranes 20 are micro porous and hydrophobic non-woven polyethylene polymer sheet materials (e.g., Tyvek® brand material sold by Dupont) and the inner membrane 30 is hydrophilic nonwoven material (e.g., Sontara EC® engineered-cloth wipes). The metal chlorite component 80 is technical grade sodium chlorite powder with 80% purity, and the acid component is sodium acid sulfate powders. The outer membrane 20 and/or inner membrane 30 may be dyed, coated, and painted with different colors. The decolorization of the membrane materials caused by chlorine dioxide production may be used as an indicator for the life of the device.

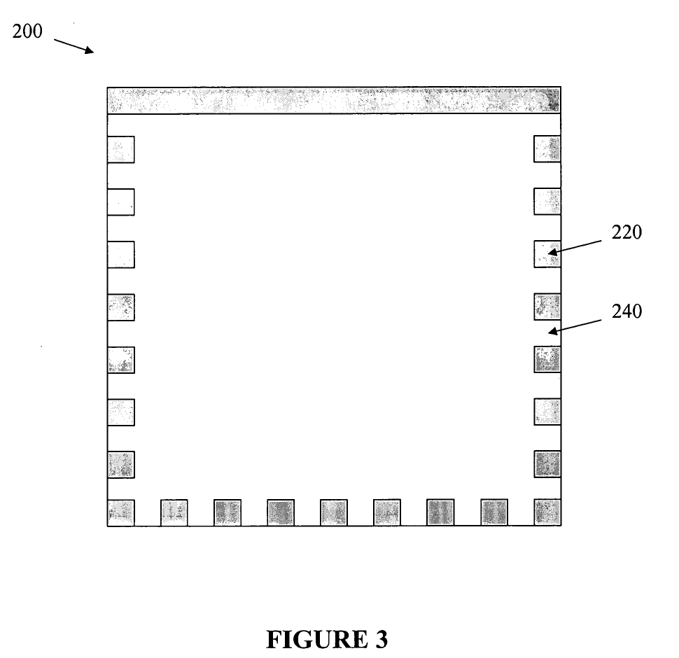

Another embodiment of the inventive device 200 is shown in FIG. 3. In this embodiment, the two outer membranes and inner membrane are mechanically heat-sealed together non-continuously along three edges of the device 200 to form a pouch with a plurality of small openings 240 distributed a round the three edges for facilitating moisture into the device 200. Along one edge of the device 200, the membranes are sealed together continuously, without the small openings 240. As shown in FIG. 3, area 220 is the area where the membranes are mechanically heat-sealed together; whereas, area 240 is the area where the membranes are not mechanically heat-sealed together, but rather, the membranes are mechanically compressed. The small openings 240 are sealed in a way such that the dry reactant components can remain inside of the device 200. These small openings 240 increase the moisture transfer rate into the device 200, the reactants' dissolution rate, the chlorine dioxide generation rate, and the facilitation rate of chlorine dioxide vapor out of the device 200. The inventive device may be designed in such a way that the number of small openings on the edges of the device may vary, depending on the desired chlorine dioxide vapor production rate.

In the embodiment as shown in FIG. 3, when the inner membrane of device 200 is constructed from materials capable of absorbing water and moisture, the device 200 is capable of transporting water into the device 200 through the wicking effect of the inner membrane. The transportation of a small amount of water into the device 200 through compressed areas 240 on the edges of the device 200 significantly shortens the time required for the chlorine dioxide vapor to be produced, which may function as a device for fast-release of chlorine dioxide vapor.

In yet another embodiment, the device comprises an envelope or chamber containing two separate pouches or enclosures. The envelope or chamber is constructed from the same material as the outer membrane material described in the above embodiments, which is moisture and chlorine dioxide permeable. One of the two separate enclosures may be provided with the metal chlorite component while the other enclosure may be provided with the acid component. The two separate pouches are preferably made from the same material as the inner membrane material described in the above embodiments, which is capable of absorbing and transporting hydrated acid and metal chlorite components. The multi-compartment devices of the present invention, as described and claimed herein, are intended to encompass multiple chambers or multiple pouch devices such as that described above.

The inventive device may be designed in different shapes, e.g., round, triangle, rectangle, parallelogram, trapezoid, diamond, octagon, hexagon, oval, etc. to suit different applications.

The following examples are provided to further illustrate the effectiveness of the inventive device.

Two different kinds of pouches were fabricated to demonstrate the effectiveness of the inventive device. The outer membranes are made of micro porous, hydrophobic non-woven polyethylene sheet material (Tyvek® brand material sold by Dupont-type 1073B) and the inner membrane is made of hydrophilic nonwoven material (e.g., Sontara EC® engineered-cloth wipers). Both pouches (A & B) have a dimension of 2.5 inch by 2.5 inch. Three edges of pouch A were mechanically heat sealed with continuous lines of 0.25 inch, and one edge of pouch A was heat sealed after the pouch A was filled with dry reactant components. One edge of pouch B was mechanically heat-sealed with a continuous line of 0.25 inch in width and the other two edges were mechanically heat sealed with four small openings on each side. These small openings have a dimension of 0.25 inch by 0.25 inch. And the last edge of pouch B was heat sealed after pouch B was filled with dry reactant components.

A 15-gallon, rectangular, open head glass chamber was designed to contain chlorine dioxide vapor produced by the inventive device. The open head of the glass tank was covered with a 3/16-inch glass plate equipped with a sampling port in the middle of the glass plate. The glass plate was placed on top of the glass chamber, and the four edges of the contact surface were sealed with vacuum grease. The two sides of the glass tank were equipped with two ports for controlling moisture levels in the glass tank, injecting a given flow of water-saturated air. The glass tank and glass plate were covered with aluminum foil to prevent the photo degradation of chlorine dioxide. A humidity/temperature monitor was placed into the glass tank to monitor the relative humidity inside the glass tank. The concentration of chlorine dioxide vapor inside the glass tank was measured using an air-sampling pump (MSA) equipped with chlorine dioxide detector tube with a detection range from 0.05 to 15 ppm.

### EXAMPLE 1

One chamber of pouch A was filled with 1 gram of powdered technical grade sodium chlorite and the other chamber of pouch A was filled with 2 grams of granular sodium acid sulfate. Similarly, pouch B was filled with 1 gram of powdered technical grade sodium chlorite and 2 grams of granular sodium acid sulfate in each chamber. Pouch A was placed into the glass chamber, and the moisture level was raised to 60% relative humidity at room temperature (˜23° C.) after the glass tank was covered. Similarly, Pouch B was placed into the glass chamber under the same conditions as pouch A. The results are shown in Table 1.

TABLE 1

| | Chlorine Dioxide | Chlorine Dioxide |
|---|---|---|
| Time | Concentration (Pouch A) | Concentration (Pouch B) |
| 6 hours | 1.4 ppm | 2.5 ppm |
| 12 hours | 13 ppm | >15 ppm |

The results shown in Table 1 demonstrate that the small openings at the two edges of pouch B increase the moisture transfer rate into the device, increase the reactants' dissolution rate and chlorine dioxide generation rate, as well as the facilitation rate of chlorine dioxide vapor out of the device.

### EXAMPLE 2

One pouch B was filled with 1 gram of powdered technical grade sodium chlorite and 2 grams of granular citric acid in each chamber. Compared to pouch B of EXAMPLE 1 under the same condition: 60% relative humidity at room temperature (˜23° C.), the results are shown in Table 2.

TABLE 2

| | Chlorine Dioxide | Chlorine Dioxide | |
|---|---|---|---|
| | Concentration | Concentration | |
| Time | (sodium acid sulfate) | (Citric Acid) | |
| 6 hours | 2.5 ppm | 0 | ppm |
| 12 hours | >15 ppm | 0.05 | ppm |
| 36 hours | — | 1.5 | ppm |

The results shown in Table 2 demonstrate that the strength of acidity affects the chlorine dioxide production. Sodium acid sulfate (pKa=1.99) is a stronger acid than citric acid (pKa 3.14); therefore, chlorine dioxide production is higher when the acidity of acid component is stronger.

### EXAMPLE 3

Three pouches B with similar formulations were prepared as follows: 1 gram of powdered technical grade sodium chlorite in one chamber and 2 grams of granular sodium acid sulfate in other chamber. These pouches were tested at different relative humidity level (40, 60, and 80% R.H.) at room temperature (˜23° C.). The results are shown in Table 3.

TABLE 3

| | Chlorine Dioxide | Chlorine Dioxide | Chlorine Dioxide |
|---|---|---|---|
| | Concentration | Concentration | Concentration |
| Time | (40% R. H) | (60% R. H) | (80% R. H) |
| 2 hours | — | — | >15 ppm |
| 6 hours | 0.05 ppm | 2.5 ppm | — |
| 12 hours | — | >15 ppm | |
| 24 hours | 0.05 ppm | — | — |

The results shown in Table 3 demonstrate that the higher the of moisture level in the air, the faster the reactant components become hydrated and come into contact with each other through the inner membrane to produce chlorine dioxide vapor.

### EXAMPLE 4

Two pouches B were prepared with similar formulations as follows: 1 gram of powdered technical grade sodium chlorite in one chamber and 2 grams of granular sodium acid sulfate in the other chamber. These pouches were placed on top of a water-filled sponge (0.5″ thickness, 2″ width and 4″ length in a plastic case), with the small opening of the pouches facing the sponge. The sponge was filled with 10 mL of water and trace amount of water for different tests. The results are shown in Table 4.

TABLE 4

| | | |
|---|---|---|
| | Chlorine Dioxide | Chlorine Dioxide |
| | Concentration | Concentration |
| Time | (trace amount of water) | (10 mL water) |

| | | | |
|---|---|---|---|
| 15 minutes | 0.8 | ppm | >15 ppm |
| 1 hours | 4 | ppm | — |
| 2.5 hours | >15 | ppm | — |

The results shown in Table 4 demonstrate that the inner membrane of the pouch functions as a wick to transport external water sources into the pouch, which facilitates the dissolution of the reactant components and increases chlorine dioxide production. It is also evident that the production of chlorine dioxide increases with the amount of water available in an external source.

### EXAMPLE 5

Two pouches B were prepared with similar formulations as follows: 1 gram of powdered technical grade sodium chlorite in one chamber and 3 grams of mixed powder of sodium acid sulfate granules and calcium chloride anhydrous powder (2 grams sodium acid sulfate and 1 gram calcium chloride). These pouches were tested at different relative humidity levels (30 and 40% R.H.), and at room temperature (23° C.). The results are shown in Table 5.

TABLE 5

| | Chlorine Dioxide | | Chlorine Dioxide | |
|---|---|---|---|---|
| Time | Concentration (30% R. H.) | | Concentration (40% R. H.) | |
| 3 hours | 0.1 | ppm | 3 | ppm |
| 6 hours | 0.9 | ppm | 10 | ppm |

| | | | |
|---|---|---|---|
| 9 hours | — | >15 | ppm |

| | | | |
|---|---|---|---|
| 12 hours | 3 | ppm | — |
| 24 hours | >15 | ppm | — |

The results shown in Table 5 demonstrate that, upon the addition of deliquescent materials (e.g. calcium chloride), chlorine dioxide production significantly increased at 40% R. H., compared to the formulation without the addition of a deliquescent material. The addition of deliquescent materials converts the moisture in the air to liquid water; subsequently increases the dissolution rate of reactant components inside the pouch. As a result, the chlorine dioxide vapor production is increased.

The present invention has been described with reference to specific embodiments and figures. These specific embodiments should not be construed as limitations on the scope of the invention, but merely as illustrations of exemplary embodiments. It is further understood that many modifications, additions and substitutions may be made to the described device for producing chlorine dioxide vapor without departing from the broad scope of the present invention.

We claim:

1. A device for producing chlorine dioxide vapor when exposed to ambient moisture, comprising:
at least two outer membranes permeable to moisture and chlorine dioxide vapor; and
at least one inner membrane sealed to the at least two outer membranes along at least two edges of the device,
wherein the outer membranes and the inner membrane together form a first compartment and a second compartment separated by the inner membrane, wherein the first compartment is provided with a first dry reactant for producing chlorine dioxide vapor, wherein the second compartment is provided with a second dry reactant for producing chlorine dioxide vapor, whereby chlorine dioxide vapor is generated and released to the atmosphere outside the device when the first dry reactant in the first compartment is hydrated by moisture penetrating the outer membranes, and the hydrated first dry reactant is transported across the inner membrane to contact the second dry reactant in the second compartment to generate chlorine dioxide vapor.

2. The device of claim 1, wherein the at least one inner membrane is sealed to the at least two outer membranes continuously along the at least two edges of the device.

3. The device of claim 1, wherein the at least one inner membrane is sealed to the at least two outer membranes non-continuously along the at least two edges of the device.

4. The device of claim 1, wherein the outer membranes are substantially impervious to water and dry reactants.

5. The device of claim 1, wherein the inner membrane has a high absorbent capacity.

6. The device of claim 1, wherein the outer membrane is constructed from a material selected from the group consisting of: naturally-occurring material, synthetic material, woven material, non-woven material, hydrophobic material, coated material, and non-coated material.

7. The device of claim 6, wherein the outer membranes is constructed from a material selected from the group consisting of: polyvinyl chloride, polyvinyl fluoride, polyvinylidene chloride, polytetrafluoroethylene, polyacrylics, polyvinyl acetate, polyethylvinyl acetate, non-soluble polyvinyl alcohol, soluble polyvinyl alcohol, polyolefins, polypropylene, polyamides, polyesters, polyurethanes, and polystyrenes.

8. The device of claim 6, wherein the outer membranes is constructed from a material selected from the group consisting of: micro porous non-woven polyethylene polymer sheet materials, micro porous non-woven polypropylene materials, expanded polytetrafluoroethylene, and Kraft paper.

9. The device of claim 1, wherein the inner membrane is constructed from a material selected from the group consisting of: natural material, synthetic material, and a combination of natural material and synthetic material.

10. The device of claim 9, wherein the inner membrane is constructed from a material selected from the group consisting of: cotton, Esparto grass, bagasse, hemp, flax, silk, wool, wood pulp, reactantly modified wood pulp, jute, rayon, ethyl cellulose, and cellulose acetate.

11. The device of claim 9, wherein the inner membrane is constructed from a material selected from the group consisting of: polyvinyl chloride, polyvinyl fluoride, polytetrafluoroethylene, polyvinylidene chloride, polyacrylics, polyvinyl acetate, polyethylvinyl acetate, non-soluble polyvinyl alcohol, soluble polyvinyl alcohol, polyolefins, polyamides, polyurethanes, and polystyrenes.

12. The device of claim 1, wherein the first dry reactant is an acid.

13. The device of claim 12, wherein the acid is selected from the group consisting of: organic acid, mineral acid, acid treated material, acid reactant, and mixtures thereof.

14. The device of claim 12, wherein the first dry reactant is selected from the group consisting of: citric acid, boric acid, lactic acid, tartaric acid, maleic acid, malic acid, glutaric acid, adipic acid, acetic acid, formic acid, sulfamic acid, and mixtures thereof.

15. The device of claim 12, wherein the first dry reactant is selected from the group consisting of: sulfuric acid, hydrochloric acid, phosphoric acid, and mixtures thereof.

16. The device of claim 12, wherein the first dry reactant is selected from the group consisting of: phosphoric anhydride and sulfuric anhydride.

17. The device of claim 12, wherein the first dry reactant is selected from the group consisting of: maleic anhydride, calcium chloride, magnesium chloride, magnesium nitrate, lithium chloride, magnesium sulfate, aluminum sulfate, sodium acid sulfate, sodium dihydrogen phosphate, potassium acid sulfate, potassium dihydrogen phosphate, and mixtures thereof.

18. The device of claim 1, wherein the second dry reactant is a metal chlorite.

19. The device of claim 18, wherein the metal chlorite is selected from the group consisting of: alkali metal chlorites, alkaline earth metal chlorites, and a combination of alkali metal chlorites and alkaline earth metal chlorites.

20. The device of claim 18, wherein the metal chlorite is selected from the group consisting of: sodium chlorite, potassium chlorite, barium chlorite, calcium chlorite, and magnesium chlorite.

21. The device of claim 1, additionally comprising an addictive selected from the group consisting of: adhesives, thickeners, penetrating agents, stabilizers, surfactants, binders, organic solids, inorganic solids, catalysts, desiccants, deliquescent materials, and fragrance-release compounds.

22. The device of claim 21, additionally comprising an additive selected from the group consisting of: potassium sulphate, calcium sulphate, ammonium sulphate, anhydrous sodium sulfate, sec. sodium phosphate, magnesium nitrate, calcium nitrate, magnesium acetate, barium chloride, magnesium chloride, aluminum chloride, calcium chloride, lithium chloride, sodium chloride, potassium chloride, ammonium chloride, potassium bromide, potassium carbonate, sodium carbonate, sodium nitrite, and mixtures thereof.

23. The device of claim 1, wherein the first and second dry reactants are impregnated on an inert carrier.

24. The device of claim 23, wherein the inert carrier is selected from the group consisting of: zeolite, kaolin, mica, bentonite, sepiolite, and diatomaceous earth synthetic silica.

25. The device of claim 1, wherein at least a portion of an outer membrane of the device is provided with a color sensitive material whereby a change in color of the material indicates a functional property of the device.
